(19) United States
(12) Patent Application Publication
(10) Pub. No.: US 2026/0139781 A1
(43) Pub. Date: May 21, 2026

(54) Female Connector Structure of Quick Connector

(71) Applicant: Yung Hsiang LI, Tainan (TW)

(72) Inventor: Yung Hsiang LI, Tainan (TW)

(73) Assignee: Yung-Hsiang LI, Tainan (TW)

(21) Appl. No.: 18/950,083

(22) Filed: Nov. 17, 2024

(51) Int. Cl. F16L 37/23

(52) U.S. Cl. CPC F16L 37/23

(57) ABSTRACT

The present invention provides a female connector structure of a quick connector, comprises a main body, a bushing, and a valve body, respectively, disposed thereon. The main body has a channel disposed therein, the channel has a first anti-leakage ring and a second anti-leakage ring provided on the wall thereof. The main body has an external thread section arranged on one end thereof and a third anti-leakage ring provided at the inner end of the external thread section. The bushing has a blocking cover extending from one end thereof and a fourth anti-leakage ring disposed therein. The valve body has a positioning piece disposed at one end of a valve stem, a plug disposed at the other end of the valve stem, an airtight ring provided on the plug, and a long tapered flow guide portion provided between the plug and the valve stem.

### BACKGROUND OF THE PRESENT INVENTION

### Field of Invention

The present invention relates to a female connector structure that improves the air-tightness and flow-guiding effects and reduces the flow resistance of a quick connector.

### Description of Related Arts

Generally, the quick connector that is commonly used for the pipeline connection of the transmission of fluids (such as liquid or gas) is mainly for the user to quickly connect or disconnect the pipeline without using tools, and the quick connector mainly includes a male connector and a female connector, the male connector is connected to the upstream pipeline, and the female connector is connected to the downstream pipeline. The male connector and the female connector can control the opening and closing of the internal valve body components by disconnecting and plugging each other, thereby determining the flow of pipeline fluid. Generally, the fluid flowing through the male connector and female connector is high-pressure fluid. Therefore, if the bonding strength between the male connector and the female connector is weak, the fluid pressure in the pipeline may easily cause the male connector to become disconnected from the female connector; or if the internal assembly gap between the male connector and the female connector is too large, the airtight effect cannot be produced, and the fluid is easy to leak out.

The structure of the female connector 1 in the prior art is shown in FIG. 1. The female connector is composed of a main body 10, an adapter body 11, a bushing 12, a valve body 13, a connecting seat 14 and a sleeve 15. The main body 10 has a first external thread section 100 arranged on the outer wall of one end thereof, a plurality of through holes 101 arranged at the other end thereof, a plurality of positioning steel balls 102 arranged in the through holes 101, a channel 103 disposed therein, a first annular groove 104 and a second annular groove 105 provided on the wall of the channel 103, a first anti-leakage ring 106 provided in the first annular groove 104, and a second anti-leakage ring 107 provided in the second annular groove 105. The adapter body 11 is assembled on one end of the main body 10. The adapter body 11 has a second external thread section 110 disposed on the wall surface of one end thereof, a first internal thread section 111 for screwing with the first external thread section 100 of the main body 10 and is provided on the inner wall of the other end thereof, a third annular groove 112 arranged in the first internal thread section 111 thereof, a third anti-leakage ring 113 arranged in the third annular groove 112, and a positioning groove 114 arranged therein. The bushing 12 is arranged in the channel 103 of the main body 10. One end of the valve body 13 is provided in the positioning groove 114 of the adapter body 11, and the other end of the valve body 13 is provided in the bushing 12. The valve body 13 has a perforation 130 on one end thereof, and a fourth anti-leakage ring 131 is provided on the other end of the valve body 13. The connecting seat 14 is assembled on the adapter body 11. The connecting seat 14 has a second internal thread section 140 that is threaded with the second external thread section 110 of the adapter body 11 and is disposed in one end thereof. The sleeve 15 is set on the main body 10 and a part of the adapter body 11. The sleeve 15 has a positioning convex ring 150 arranged on an inner wall thereof. However, although the female connector 1 in the prior art can be firmly plugged and positioned with the male connector by the positioning steel balls 102, the third anti-leakage ring 113 of the female connector 1 is provided in the third annular groove 112 of the adapter body 11, and is provided at the front end of the first external thread section 100 of the main body 10 and the first internal thread section 111 of the adapter body 11, which are threaded together. Therefore, the fluid flowing through the female connector 1 is easy to leak out from between the screw threads of the first external thread section 100 and the first internal thread section 111, and the airtightness effect is not good. Moreover, when the fluid flows through the channel 103 of the main body 10 and touches the valve body 13, it is easy to produce flow resistance, so that the flow of fluid is blocked, and the transmission of fluid is relatively poor.

### SUMMARY OF THE PRESENT INVENTION

The main purpose of the present invention is to provide a female connector structure of a quick connector that can increase the air tightness and the flow diversion effect of the female connector and reduce the flow resistance.

A female connector structure of a quick connector, mainly comprises a main body, a first spring, a sleeve, a bushing, a second spring, a valve body, and a connecting seat, respectively, disposed thereon, wherein the main body has a channel disposed therein, the channel has a limiting flange, a first annular groove, and a second annular groove, respectively, provided on the wall thereof, wherein a first anti-leakage ring is installed in the first annular groove, and a second anti-leakage ring is installed in the second annular groove, wherein the main body has an external thread section arranged on one end thereof and a third annular groove provided at the inner end of the external thread section, wherein a third anti-leakage ring is installed in the third annular groove, wherein the main body has a retaining rim arranged on the outer wall thereof, wherein the main body has a plurality of through holes connected with the channel and is provided on the other end thereof, wherein a plurality of positioning steel balls are installed in the through holes, wherein the main body has a positioning stopper protrudingly provided on the other end thereof; wherein the first spring is sleeved on the outer wall of the main body; wherein the sleeve is sleeved on the main body and the first spring, wherein the sleeve has a positioning convex ring provided on the inner wall thereof; wherein the bushing is arranged in the channel of the main body, wherein the bushing has a limiting protrusion disposed on the outer wall thereof, a blocking cover extending from one end thereof, and a fourth annular groove disposed therein, wherein a fourth anti-leakage ring provided in the fourth annular groove; wherein the second spring is sleeved on the bushing and disposed in the channel of the main body; wherein the valve body is arranged in the main body, the bushing, and the connecting seat, wherein the valve body has a valve stem disposed thereon, a positioning piece disposed at one end of the valve stem, a perforation disposed on the positioning piece, a plug disposed at the other end of the valve stem, a fifth annular groove provided on the plug, an airtight ring provided in the fifth annular groove, and a long tapered flow guide portion provided between the plug and the valve stem; wherein the connecting seat is assembled on the main body, wherein one end of the connection seat is set as a connecting end, and the other end of the connection seat is set as a plug-in end, wherein the plug-in end has an internal thread section disposed therein, wherein the internal thread section is screwed together with the external thread section of the main body, wherein the positioning piece of the valve body is arranged in the connecting seat.

According to the female connector structure of the quick connector of the present invention, the sleeve has a ring groove provided on the outer wall thereof, wherein an identification collar is sleeved in the ring groove.

The female connector structure of the quick connector of the present invention is advantaged in that: the air tightness and the diversion effect of the female connector can be improved, and the effect of reducing the flow resistance can be achieved.

### BRIEF DESCRIPTION OF THE DRAWINGS

FIG. 1 is an assembled sectional view of a conventional female connector.

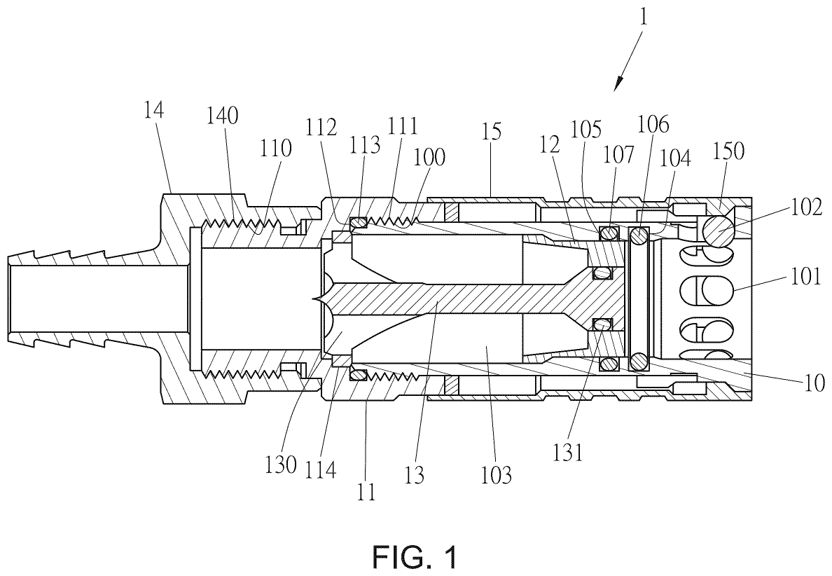

FIG. 2 is an exploded view of an embodiment of the present invention.

FIG. 3 is a perspective view of the embodiment of the present invention.

FIG. 4 is an assembled sectional view of the embodiment of the present invention.

### DETAILED DESCRIPTION OF THE PREFERRED EMBODIMENT

Regarding the technical means adopted by the present invention to achieve the above-mentioned purposes and effects, the best and feasible embodiments are enumerated and shown in the drawings, and are described in detail as follows:

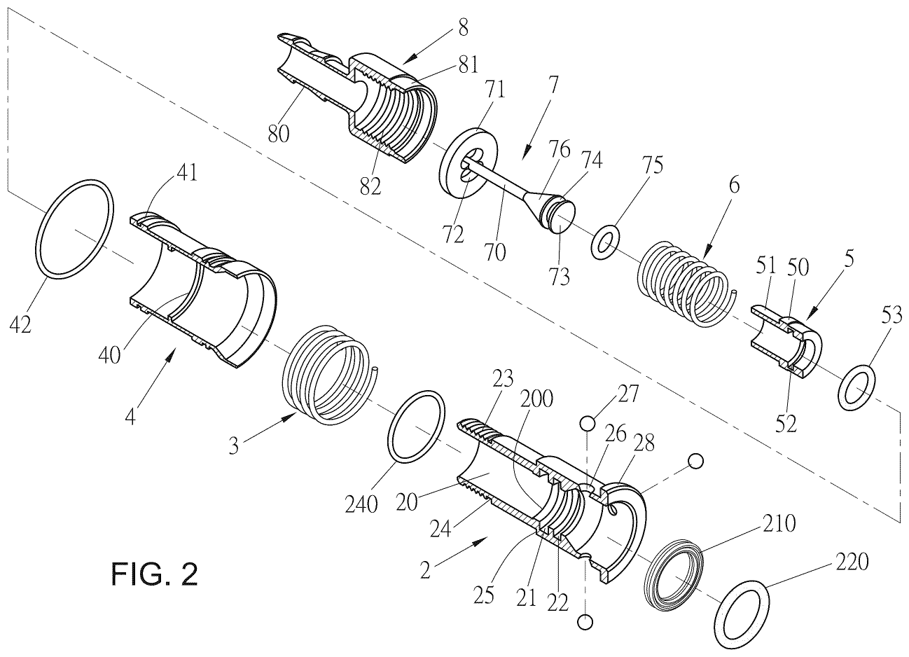

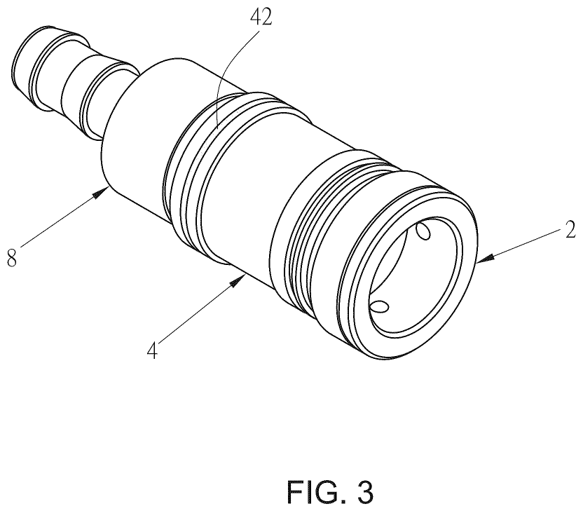

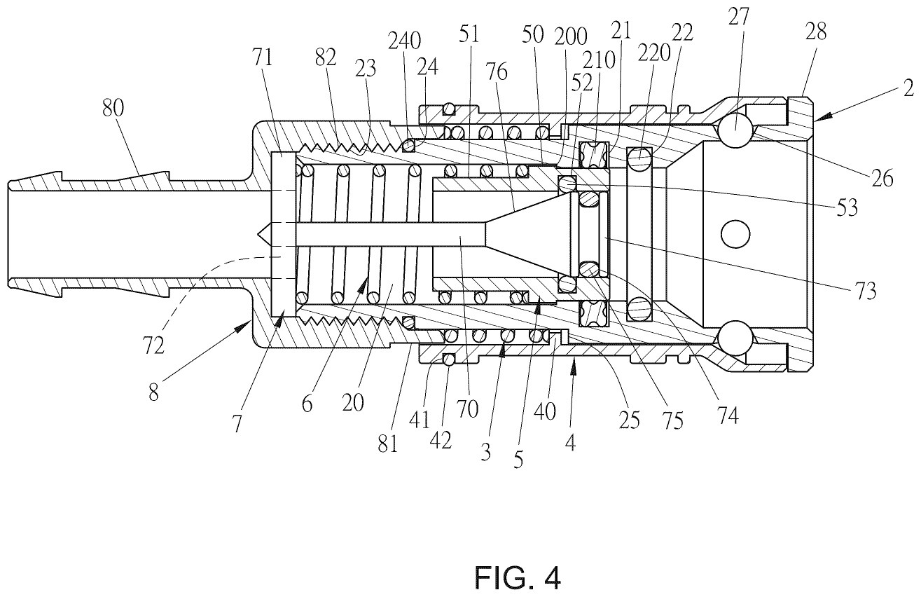

In the embodiment of the present invention, as shown in FIGS. 2 to 4, a female connector structure of a quick connector mainly includes a main body 2, a first spring 3, a sleeve 4, a bushing 5, a second spring 6, a valve body 7, and a connecting seat 8, respectively, disposed thereon, wherein the main body 2 has a channel 20 disposed therein, the channel 20 has a limiting flange 200, a first annular groove 21, and a second annular groove 22, respectively, provided on the wall thereof, wherein a first anti-leakage ring 210 is installed in the first annular groove 21, and a second anti-leakage ring 220 is installed in the second annular groove 22, wherein the main body 2 has an external thread section 23 arranged on one end thereof, and a third annular groove 24 provided at the inner end of the external thread section 23, wherein a third anti-leakage ring 240 is installed in the third annular groove 24, wherein the main body 2 has a retaining rim 25 arranged on an outer wall thereof, wherein the main body 2 has a plurality of through holes 26 connected with the channel 20 and is provided on the other end thereof, wherein a plurality of positioning steel balls 27 are installed in the through holes 26, wherein the main body 2 has a positioning stopper 28 protrudingly provided on the other end thereof; wherein the first spring 3 is sleeved on the outer wall of the main body 2; wherein the sleeve 4 is sleeved on the main body 2, wherein the sleeve 4 has a positioning convex ring 40 provided on the inner wall thereof, and a ring groove 41 provided on the outer wall thereof, wherein an identification collar 42 is set in the ring groove 41; wherein the bushing 5 is arranged in the channel 20 of the main body 2, wherein the bushing 5 has a limiting protrusion 50 disposed on the outer wall thereof, a blocking cover 51 extending from one end thereof, and a fourth annular groove 52 disposed therein, wherein a fourth anti-leakage ring 53 provided in the fourth annular groove 52; wherein the second spring 6 is sleeved on the bushing 5 and disposed in the channel 20 of the main body 2; wherein the valve body 7 is arranged in the main body 2 and the bushing 5, wherein the valve body 7 has a valve stem 70 disposed thereon, a positioning piece 71 disposed at one end of the valve stem 70, a perforation 72 disposed on the positioning piece 71, a plug 73 disposed at the other end of the valve stem 70, a fifth annular groove 74 provided on the plug 73, an airtight ring 75 provided on the fifth annular groove 74, and a long tapered flow guide portion 76 provided between the plug 73 and the valve stem 70; wherein the connecting seat 8 is assembled on the main body 2, wherein one end of the connection seat 8 is set as a connecting end 80, and the other end of the connection seat 8 is set as a plug-in end 81, wherein the plug-in end 81 has an internal thread section 82 disposed therein, wherein the internal thread section 82 is screwed together with the external thread section 23 of the main body 2, so that, that is, the female connector structure of the quick connector.

When assembling the embodiment of the present invention, refer to FIG. 2˜4, firstly, the first anti-leakage ring 210 is arranged in the first annular groove 21 of the main body 2, the second anti-leakage ring 220 is arranged in the second annular groove 22 of the main body 2, the third anti-leakage ring 240 is arranged in the third annular groove 24 of the main body 2, and the identification collar 42 is arranged in the ring groove 41 of the sleeve 4, and then the sleeve 4 is arranged on the main body 2, and the first spring 3 is arranged in the sleeve 4 and is sleeved on the outer wall of the main body 2, so that one end of the first spring 3 is abutted against the positioning convex ring 40 of the sleeve 4. Then, the fourth anti-leakage ring 53 is arranged in the fourth annular groove 52 of the bushing 5, and the bushing 5 is arranged in the channel 20 of the main body 2, so that the limiting protrusion 50 of the bushing 5 abuts against the limiting flange 200 of the main body 2. The second spring 6 is arranged in the channel 20 of the main body 2 and is sleeved on the blocking cover 51 of the bushing 5, and one end of the second spring 6 abuts against one side of the limiting protrusion 50 of the bushing 5. In addition, the airtight ring 75 is arranged on the fifth annular groove 74 of the valve body 7, the plug 73 of the valve body 7 is arranged in the bushing 5, the positioning piece 71 of the valve body 7 is abutted against the end face of the main body 2, and the other end of the second spring 6 is abutted against the positioning piece 71. Then, the internal thread section 82 of the connecting seat 8 is screwed with the external thread section 23 of the main body 2, and the plug-in end 81 of the connecting seat 8 is arranged on the outer wall of the main body 2 and is abutted against the other end of the first spring 3, so that the assembly can be completed.

When the present invention is used, the main body 2 of the female connector and the male connector can be plugged into each other to transmit or block the pipeline fluid, which is very convenient in use. The present invention uses multiple leakage prevention barriers such as the first anti-leakage ring 210, the second anti-leakage ring 220 in the main body 2, and the fourth anti-leakage ring 53 in the bushing 5, and the third anti-leakage ring 240 is provided at the inner end of the external thread section 23 of the main body 2, which can prevent fluid from leaking from the threaded parts and improve the overall airtight effect of the female connector. In addition, the color of the identification collar 42 on the sleeve 4 can be used to easily identify the type of fluid transmitted by the pipeline. For example, the green identification collar 42 is cold fluid, the red identification collar 42 is hot fluid, etc. Moreover, the valve body 7 of the present invention is provided with the flow guide portion 76 with an elongated slope, which can increase the diversion effect, and the blocking cover 51 extended by the bushing 5 can isolate the vortex caused by the fluid flowing through the gap of the second spring 6, can effectively reduce flow resistance and make pipeline fluid transmission smoother.

In summary, the present invention has indeed achieved the anticipated objectives and effects and is more ideal and practical than the prior art. However, the above-mentioned embodiments are only specific explanations for the preferred embodiments of the present invention, and this embodiment is not intended to limit the scope of the present invention. All equivalent variations and modifications completed under the technical means disclosed in the present invention should be included in the scope of patent protection of the present invention.

What is claimed is:

1. A female connector structure of a quick connector, mainly comprising a main body, a first spring, a sleeve, a bushing, a second spring, a valve body, and a connecting seat, respectively, disposed thereon, wherein the main body has a channel disposed therein, the channel has a limiting flange, a first annular groove, and a second annular groove, respectively, provided on the wall thereof, wherein a first anti-leakage ring is installed in the first annular groove, and a second anti-leakage ring is installed in the second annular groove, wherein the main body has an external thread section arranged on one end thereof and a third annular groove provided at the inner end of the external thread section, wherein a third anti-leakage ring is installed in the third annular groove, wherein the main body has a retaining rim arranged on the outer wall thereof, wherein the main body has a plurality of through holes connected with the channel and is provided on the other end thereof, wherein a plurality of positioning steel balls are installed in the through holes, wherein the main body has a positioning stopper protrudingly provided on the other end thereof; wherein the first spring is sleeved on the outer wall of the main body; wherein the sleeve is sleeved on the main body and the first spring, wherein the sleeve has a positioning convex ring provided on the inner wall thereof; wherein the bushing is arranged in the channel of the main body, wherein the bushing has a limiting protrusion disposed on the outer wall thereof, a blocking cover extending from one end thereof, and a fourth annular groove disposed therein, wherein a fourth anti-leakage ring provided in the fourth annular groove; wherein the second spring is sleeved on the bushing and disposed in the channel of the main body; wherein the valve body is arranged in the main body and the bushing, wherein the valve body has a valve stem disposed thereon, a positioning piece disposed at one end of the valve stem, a perforation disposed on the positioning piece, a plug disposed at the other end of the valve stem, a fifth annular groove provided on the plug, an airtight ring provided in the fifth annular groove, and a long tapered flow guide portion provided between the plug and the valve stem; wherein the connecting seat is assembled on the main body, wherein one end of the connection seat is set as a connecting end, and the other end of the connection seat is set as a plug-in end, wherein the plug-in end has an internal thread section disposed therein, wherein the internal thread section is screwed together with the external thread section of the main body, wherein the positioning piece of the valve body is arranged in the connecting seat.

2. The female connector structure of the quick connector, as recited in claim 1, wherein the sleeve has a ring groove provided on the outer wall thereof, wherein an identification collar is sleeved in the ring groove.
